(19) United States
(12) Patent Application Publication
(10) Pub. No.: US 2015/0205633 A1
(43) Pub. Date: Jul. 23, 2015

(54) TASK MANAGEMENT IN SINGLE-THREADED ENVIRONMENTS

(71) Applicant: Google Inc., Mountain View, CA (US)

(72) Inventors: Joseph John KAPTUR, New York, NY (US); Daniel Enrique FERRARA, New York, NY (US)

(73) Assignee: Google Inc., Mountain View, CA (US)

(21) Appl. No.: 13/902,559

(22) Filed: May 24, 2013

(51) Int. Cl. G06F 9/48

(52) U.S. Cl. CPC G06F 9/4881

(57) ABSTRACT

Various aspects of the subject technology relate to executing a task in a single-threaded environment. A first set of subtasks for the task may be generated and scheduled for execution in a runtime environment with a single logical thread based on a first function. The first set of subtasks may be executed based on the scheduling of the first set of subtasks, wherein the execution of the first set of subtasks generates a set of key/value pairs. A second set of subtasks may also be generated and scheduled based on the execution of a second function on the set of key/value pairs. The second set of subtasks may be executed based on the scheduling of the second set of subtasks.

### BACKGROUND

The present disclosure generally relates to runtime environments for executing computer code and, in particular, to single-threaded runtime environments.

Single-threaded environments, such as web browsers or JavaScript runtimes, provide a runtime environment in which programming code may be executed. The runtime environment provides a single logical thread for execution. As a result, the runtime environment is unable to execute two or more tasks (e.g., two pieces of programming code) at the same time. When a task is being executed in the runtime environment, other tasks such as ones that manage the user interface are unable to execute. Accordingly, the rest of the runtime environment (e.g., the web browser or JavaScript) may become unresponsive.

If the task being executed is a computationally expensive task that requires more time to complete, the other tasks may not have a change to be executed for a lengthy amount of time and the unresponsiveness may become detectable or even bothersome to a user. Only after the computationally expensive task has finished executing and the other tasks that manage the user interface are able to execute can the user interface become responsive again. Although the example above discusses user interface tasks that are not able to be executed, the execution of other tasks in the runtime environment may also be delayed by a computationally expensive task.

### SUMMARY

Various aspects of the subject technology relate to a computer-implemented method for executing a task in a single-threaded environment. The method includes receiving a data set, a first function, and a second function for the task, wherein the data set comprises a plurality of elements, generating a first set of subtasks based on execution of the first function on each element of the plurality of elements, scheduling the first set of subtasks for execution in a runtime environment with a single logical thread, and executing, using at least one processor in the runtime environment, the first set of subtasks based on the scheduling of the first set of subtasks, wherein the execution of the first set of subtasks generates a set of key/value pairs. The method further includes generating a second set of subtasks based on execution of the second function on the set of key/value pairs, scheduling the second set of subtasks in the runtime environment, and executing, using the at least one processor in the runtime environment, the second set of subtasks based on the scheduling of the second set of subtasks.

Various aspects of the subject technology relate to a non-transitory machine-readable medium including instructions stored therein, which when executed by a machine, cause the machine to perform operations. The operations may include receiving a data set, a first function, and a second function, wherein the data set comprises a plurality of elements, generating a first set of subtasks based on execution of the first function on each element of the plurality of elements, scheduling the first set of subtasks for execution in a single-threaded environment, and executing, in the single-threaded environment, the first set of subtasks based on the scheduling of the first set of subtasks, wherein the execution of the first set of subtasks generates a set of key/value pairs. The operations further include generating a second set of subtasks based on execution of the second function on the set of key/value pairs, scheduling the second set of subtasks in the single-threaded environment, and executing, in the single-threaded environment, the second set of subtasks based on the scheduling of the second set of subtasks.

Various aspects of the subject technology relate to a system for executing programming code. The system may include at least one processor and a machine-readable medium comprising instructions stored therein, which when executed by a processor, cause the processor to perform operations. The operations may include receiving a data set, a first function, and a second function, wherein the data set comprises a plurality of elements, generating a first set of subtasks based on execution of the first function on each element of the plurality of elements, scheduling the first set of subtasks for execution in a single-threaded environment, and executing, in the single-threaded environment, the first set of subtasks based on the scheduling of the first set of subtasks, wherein the execution of the first set of subtasks generates a set of key/value pairs. The operations may further include generating a second set of subtasks based on execution of the second function on the set of key/value pairs, scheduling the second set of subtasks in the single-threaded environment, and executing, in the single-threaded environment, the second set of subtasks based on the scheduling of the second set of subtasks.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a block diagram illustrating an example system which may provide a single logical threaded runtime environment, in accordance with various aspects of the subject technology.

FIG. 2 is a flow chart illustrating an example process for executing a task in a runtime environment with a single logical thread, in accordance with various aspects of the subject technology.

FIG. 3 is a diagram that illustrates pseudocode for an example map function and an example reduce function for a particular map/reduce task, in accordance with various aspects of the subject technology.

FIG. 4 is a diagram that illustrates pseudocode for an example map/reduce object, in accordance with various aspects of the subject technology.

FIG. 5 is a block diagram illustrating a computer system with which any of the clients, servers, or systems described herein may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Various aspects of the subject technology relate to executing a task in a single-threaded environment by splitting the task into a number of subtasks, scheduling the execution of the subtasks, and executing the subtasks according to the schedule. For example, a framework may be configured to receive a data set that the task is to be performed on along with two or more functions that are to be used to perform the task. The task may be split into a number of smaller subtasks by generating sets of subtasks based on the received functions. As will be discussed in further detail below, according to some aspects of the subject technology, the task may be in the form of a map/reduce task and the functions that may be used to perform the task may include a map function and a reduce function.

By splitting a large task into a number of smaller subtasks and executing the smaller subtasks along with other operations not related to the large task (e.g., other tasks, subtasks, or operations) according to a schedule, the runtime environment may be able to execute the other operations while also executing the large task. In a sense, a parallel-processing environment may be simulated. Accordingly, the execution of the large task may not monopolize the processing time of the runtime environment when other operations not related to the large task are waiting to be executed. When the other tasks, subtasks, or operations are related to user interface processes (e.g., receiving input from a user, outputting data, or performing another user interface process), being able to execute these other operations may allow a user interface to be perceived as being more responsive and potentially less frustrating to a user because the large task is not required to be completed before other user interface operations are executed.

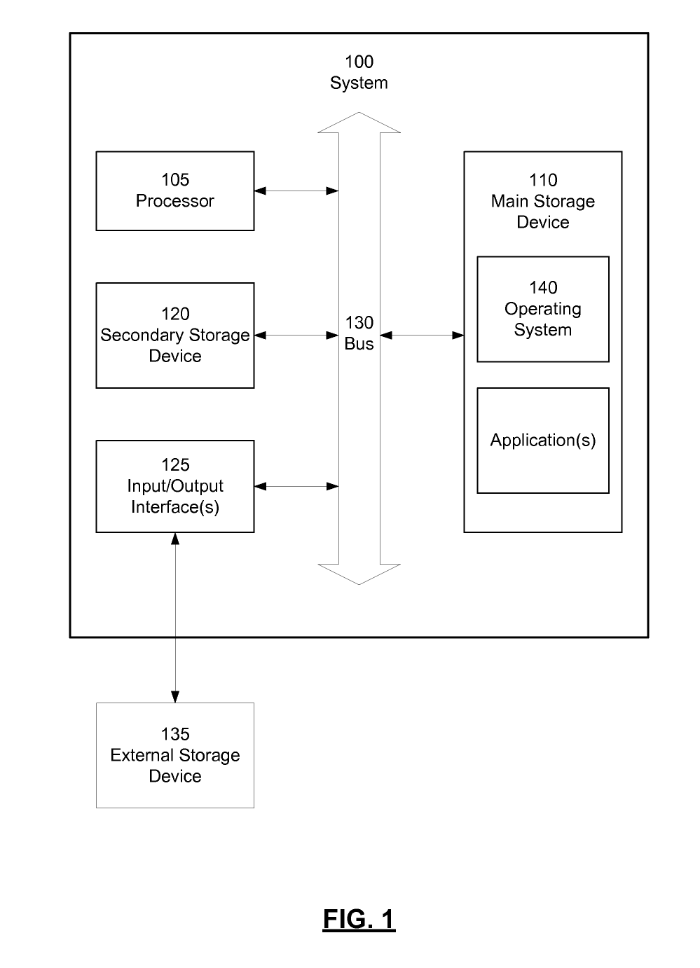

FIG. 1 is a block diagram illustrating an example system 100 which may provide a single logical threaded runtime environment, in accordance with various aspects of the subject technology. The system 100 can be implemented as a computer, a device, or any other machine or component capable of hosting a runtime environment capable of executing programming code. While the system 100 is shown in one configuration in FIG. 1, in other configurations, the system 100 may include additional, alternative, and/or fewer components.

The system 100 may include a processor 105, a main storage device 110, a secondary storage device 120, and one or more input/output interfaces 125 which may all communicate with one another via a bus 130. The one or more input/output interfaces 125 may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker). One or more input/output interfaces 125 may also be configured to communicate with an external storage device 135.

The processor 105 may be configured to control the various components of the system 100 and perform various tasks by executing machine-readable instructions (e.g., computer programming code) that are stored in the main storage device 110, the secondary storage device 120, or the external storage device 135. The processor 105 may further include one or more cores (e.g., a single or multi-core processor) capable of providing a runtime environment with a single logical thread and, in other aspects, the system 100 may include multiple processors that are capable of providing a runtime environment with a single logical thread.

The main storage device 110 may include cache memory, random access memory, or one or more hard drives. The main memory device may contain one or more sets of machine-readable instructions that may be executed by the processor in one or more sequences. For example, the main memory device 110, as seen in FIG. 1, includes a root file system that includes an instance of an operating system 140 for the computer system 100 as well as one or more applications.

Other applications (e.g., a web browser or other JavaScript runtime environment) or machine-readable code may also reside on the main storage device 110, the secondary storage device 120, or the external storage device 135. The secondary storage device 120 may be a secondary hard drive, an internal memory card (e.g., a secure digital (SD) card or other flash card), a non-removable internal memory chip, or some other memory device. Similarly, the external storage device 135 may be a removable data storage device such as a universal serial bus (USB) drive or a secure digital (SD) card. The external storage device 135 may also take other forms (e.g., an external hard drive).

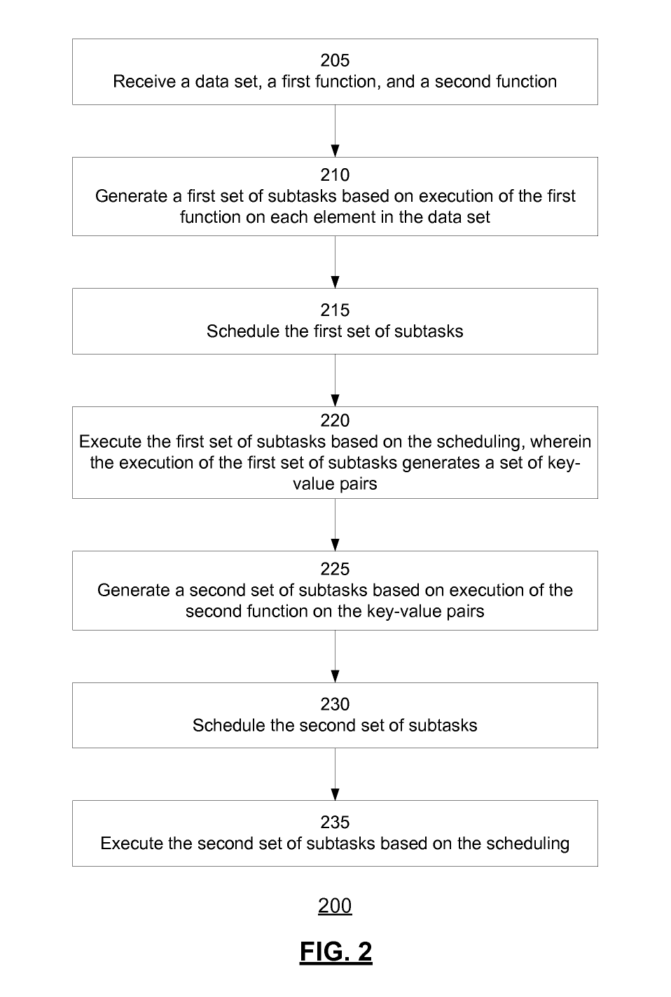

FIG. 2 is a flow chart illustrating an example process 200 for executing a task in a runtime environment with a single logical thread, in accordance with various aspects of the subject technology. Although the steps are shown in one particular order, other orderings of steps are also possible. Furthermore, the steps in process 200 may be a part of a larger process. Various aspects of the subject technology relate to a programming technique that can be used to execute a task in a single-threaded environment by splitting the task into a number of subtasks, scheduling the execution of the subtasks, and executing the subtasks according to the schedule.

For example, at block 205, a system may be configured to receive a data set that the task (e.g., a map/reduce task) is to be performed on along with two or more functions that are to be used to perform the task (e.g., a map function and a reduce function). These items may be received from another system (e.g., over a network connection) or the same system. The items may be received in, for example, a function call including parameters that correspond to the data set and the two or more functions. In FIG. 2, the example process 200 shows two functions being received, however, other processes according to other aspects may similarly be used with additional functions.

The data set that the task is to be performed on may include a number of elements or subcomponents. For example, the data set may be a spreadsheet or table and each cell in the spreadsheet or table may be an element of the data set. The data set may also be a database where each record in the database is an element in the data set. Other data structures may include linked lists, queues, arrays, stacks, graphs, trees, text files, logs, maps, or other types of data structures. In another example, the data set may also be a list of web pages, where each web page in the list is an element of the data set.

In response to receiving the data set and the two functions, at block 210, the system may generate a first set of subtasks based on the execution of one of the functions on the data set. For example, the first set of subtasks may include a number of subtasks where each subtask involves the execution of the function on one of the elements in the data set. According to some aspects of the subject technology, each element in the data set may have a corresponding subtask in the first set of subtasks where the function is to be executed on that element.

After the first set of subtasks has been generated, the system may schedule the first set of subtasks at block 215. As will be discussed in more detail further blow, the subtasks may be scheduled such that the execution of one or more of the subtasks is spaced out. By spacing the subtasks out, other operations not related to the task may be executed in the single-threaded environment. For example, operations that relate to user interface functions may be executed during these spaces such that a user interface may appear to be more responsive to user input than if the entire task or all subtasks associated with the task were executed before other operations may be executed.

At block 220, the system may execute the first set of subtasks in accordance with the scheduling. As described above, the execution of the first set of subtasks may cause the first of the two functions received by the system to be executed on each element of the data set. The execution of the first set of subtasks may result in the creation a set of key/value pairs. In some cases, the keys may not necessarily be unique.

These key/value pairs may be used to generate, at block 225, a second set of subtasks that involves the execution of the second of the two functions being performed on the key/value pairs. For example, each subtask in the second set of subtasks may be configured to execute the second function on all the values associated with one of the keys created by the execution of the first set of subtasks. The second set of subtasks may also be scheduled (at block 230) and executed in accordance with a schedule (at block 235).

After the second set of subtasks is executed, in some cases, the task may be complete. In other aspects of the subject technology, additional subtasks or operations may need to be executed in order for the task to be complete. These additional subtasks or operations may also be scheduled such that their execution is spaced out such that other operations not related to the task may also be executed.

The first set of subtasks, the second set of subtasks, and/or the additional subtasks or operations to be performed after the execution of the second set of subtasks may be scheduled in various ways such that other operations may be intermittently executed while the many subtasks needed to finish the task are being executed. The scheduling of the operations may be based on one or more parameters that may be set as a default, set by a system administrator, or provided to the system (e.g., via a function parameter in a function call).

According to some aspects, the scheduling may be based on a percentage parameter that specifies the percentage of time that the single-threaded environment is to execute subtask (or non-subtask operations). For example, the system may include a timer (e.g., a physical timer or a system timer) that may be used to determine an amount of time used to execute one or more subtasks related to the task as well as an amount of time used to execute other operations not related to the task. The system may be configured to schedule to execution of the subtasks and the other operations such that, while there are other operations awaiting execution, the time used for the execution of the subtasks and the time used for execution of the other operations is in accordance with the percentage parameter.

According to other aspects, the scheduling may be based on a time parameter that specifies the amount of time that subtasks that are related to the task are to be executed before another operation not related to the task will be performed. Alternatively, the time parameter may specify an amount of time that is to occur between the execution of one subtask related to the task and the execution of another subtask related to the task. During this time between subtasks, other operations not related to the task may be performed.

According to other aspects, the scheduling of one subtask may be based on the execution of the previous subtask. For example, if the execution of a first subtask took t seconds, the next subtask may be scheduled x(t) seconds after the first subtask finished, where x is a function of t. The function x(t) may be, for example, equal to t itself or 50% of t or any other function of t. In another variation, a space between executions of subtasks may be scheduled if the execution of subtasks exceeds a threshold amount of time (e.g., 500 milliseconds).

In still other aspects of the subject technology, the scheduling of the tasks may be based on a combination of different parameters such as the parameters discussed above. Furthermore, the scheduling of the first and second set of tasks may be done at the same time or on the fly as subtasks are generated and other operations unrelated to the task are called for.

According to some aspects of the subject technology, the task to be executed by the system is a map/reduce task and two functions that may be used to perform the map/reduce task. The system may implement a map/reduce framework (e.g., machine-readable instructions) in order to manage the execution of the map/reduce task and the two functions. The two functions may include a map function and a reduce function. According to one aspect of the subject technology, the map function may be configured to generate none, one, or more intermediate data values (e.g., key/value pairs) based on an element of the input data set. The reduce function, on the other hand, may be configured to merge or otherwise combine the intermediate data values (e.g., combining intermediate values that share the same key) in a way to produce final output data. The map function and the reduce function may be specific to a particular application or to a specific map/reduce task.

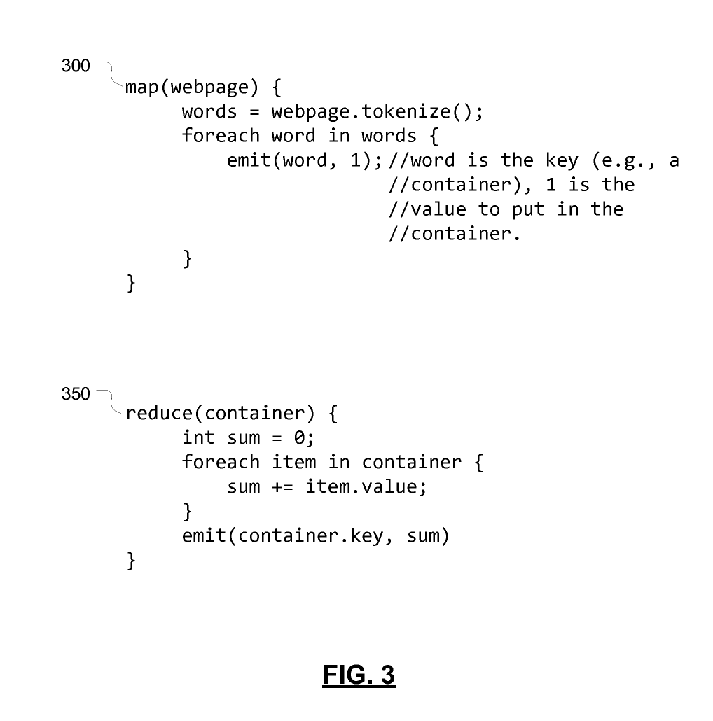

FIG. 3 is a diagram that illustrates pseudocode for an example map function 300 and an example reduce function 350 for a particular map/reduce task, in accordance with various aspects of the subject technology. This particular map/reduce task may be configured to determine how many times every word appears on a set of web pages. Depending on how many web pages are in the set (e.g., all web pages indexed by a web crawler), determining how many times every word appears on a set of web pages may require a large amount of computing resources and execution time in a runtime environment. In order to allow other operations not related to the determining of how many times every word appears on a set of web pages, the map/reduce task may partition this undertaking into a number of subtasks using the map function 300 and the reduce function 350.

The framework may be configured to call the map function 300 on each web page in the set of web pages. When called, the map function 300 is configured to operate on one web page and tokenize the web page (e.g., parse the text in the web page in order to identify the words in the web page). After the web page is tokenized, the map function 300 is configured to count each word in the web page, using the word as a result key.

After the map functions 300 are executed on each web page in the set of web pages, the framework puts together all the key/value (e.g., container/value) pairs with the same key and calls the reduce function 350 on each key (e.g., container). The reduce function 350 is configured to merge the values associated with a key by, in this case, summing all of the values associated with the key (e.g., the word) to find the total number of appearances of the word across all of the web pages in the set.

The executions of the map functions 300, the reduce functions 350, and other the operations related to the map/reduce task may all be scheduled in a manner that allows other operations not related to the map/reduce task to be performed without having to wait for the entire map/reduce task to be completed. Although FIG. 3 shows one example of the map function 300 and the reduce function 350, other map functions and reduce functions for other types of map/reduce tasks may also be used.

The framework may manage the execution of the map function, the reduce function, and the map/reduce task as a whole. The framework may include a map/reduce object, additional functions, interfaces, or other code that aid the system in distributing subtasks serially in a single-threaded environment (e.g., a runtime environment with a single logical thread). These subtasks are scheduled serially such that other operations (e.g., user interface operations) not related to the map/reduce tasks may continue to be executed as a map/reduce task is being executed.

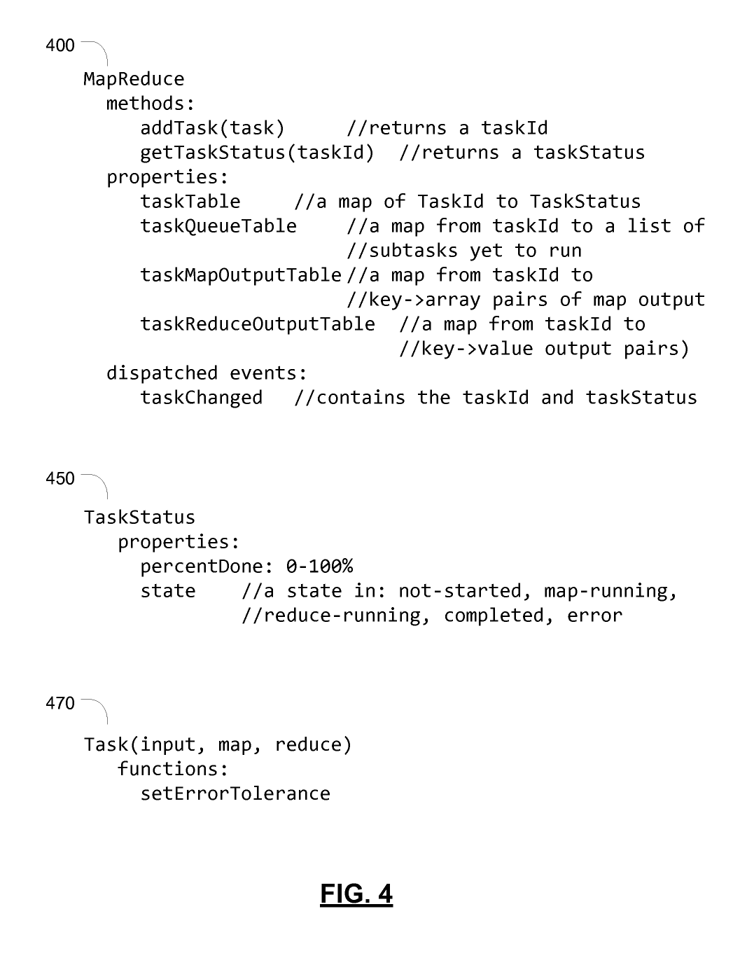

FIG. 4 is a diagram that illustrates pseudocode for an example map/reduce object 400, in accordance with various aspects of the subject technology. The map/reduce object 400 may have a schema that includes a number of methods, properties, and dispatched events. The methods may include scheduling a task by adding a task to a queue (e.g., addTask(task)) and obtaining a status of a task (e.g., getTaskStatus(taskId)). A status of a task (e.g., a TaskStatus 450) may be another object related to the map/reduce object 400 that indicates a percentage that an associated map/reduce object 400 has completed as well as a state of the associated map/reduce object 400. Each map/reduce object 400 may be associated with properties such as a task table (e.g., taskTable) that maps each task to a status, a task queue table that maps each task to a list of subtasks that have not been executed, a task map output table that maps a task to key/array pairs of map output, and a task reduce output table that maps a task to key/value output pairs.

A map/reduce object 400 may be initialized with an empty task queue and an empty taskStatus table. According to some aspects, the map/reduce object 400 may also be initialized with a scheduling parameter such as, for example, a percentage of execution time that is to be reserved for other operations not associated with the map/reduce task. A task may be started by creating a task object 470 whose schema is illustrated in FIG. 4. The task object may be created using the function call and specifying an input data set, a map function, and a reduce function. The function call may be provided by, for example, a programmer or code being executed (e.g., a script).

When a MapReduce.addTask instruction is executed, the system may be configured to bind the map function to each element of the input data set, thereby providing a set (e.g., an array or list) of executable functions (subtasks). The system may then assign the task a randomly generated taskId and add the taskId to the taskStatus table with properties {0%, not-started}. The system may also add an element to the taskQueueTable that maps the taskId to the queue of subtasks (e.g., the set of subtasks) and return the taskId.

According to some aspects of the subject technology, the scheduling of the subtask may be implemented using a timer associated with the map/reduce object 400. For example, the map/reduce object 400 may have a timer that enables other operations not related to the map/reduce task to be executed in the single-threaded runtime environment while the map/reduce task is executed. The timer may be configured to intermittently “tick” each time period (e.g., a predetermined clock cycle).

Whenever the timer ticks, the system may be configured to determine the next taskId that will have a subtask run. This enables multiple tasks (e.g., taskIds) to appear to run in parallel, or simulate parallel processing, without having to wait for another task to be completed. The system may dequeue the first subtask from the taskQueueTable, which may include an ordered list of taskIds, and execute the subtask. Any output that results from the execution of the subtask may be collected and stored in the taskMapOutputTable (if the subtask was an execution of a map function) or the taskReduceOutputTable (if the subtask was an execution of a reduce function). If an error occurs in the execution of the subtask, the system may update the taskStatus table with the error information (e.g., number of errors, the type of errors, etc.) According to some aspects, if the number exceeds the setErrorTolerance for the task or if the error is of a particular task, the system may cancel the task by clear out the remaining subtasks and set the taskStatus to “error.”

If the subtask was an execution of a map function and there are no more subtasks for the taskID in the taskQueueTable, then the system may bind the user-specified reduce function to every member of the taskMapOutputTable and enqueue each function into the taskQueueTable. The system may then update the taskTable with the new status (e.g., update the percentage complete or the state from “map-running” to “reduce-running”). The system may also dispatch a taskChanged event with the task's new status. Next, the system determines the next time (e.g., according to a schedule) that a subtask should be executed and set a timer (e.g., a native JavaScript timer) so that when a certain amount of time elapses and the next time arrives, the next subtask may be executed. The next time may be scheduled in a manner that allows other operations to execute. For example, if other operations are user interface operations, these operations may also be executed in order to preserve the responsiveness of the user interface.

Accordingly, by separating the map/reduce task into a number of smaller subtasks, the system allows for multiple tasks to be executed in a runtime environment with a single logical thread in a manner that simulates parallel processing. Furthermore, the map/reduce framework is flexible and may be used for many possible applications. The framework also allows for reports to be provided on the portion of the task performed by, for example, showing progress bars or other indications. Also, by allowing the system to receive scheduling parameters, developers may be able to tune performance and adjust the minimum amount of time that other tasks are able to be performed.

Some aspects of the subject technology may be applied or used within the context of a web application using JavaScript. Furthermore, aspects of the subject technology may be used without the need to use web workers that are executed from a web page and run in the background, independently of user-interface scripts that may be executing in the same web page. Although, aspects of the subject technology may also be used in other single-threaded environments as well.

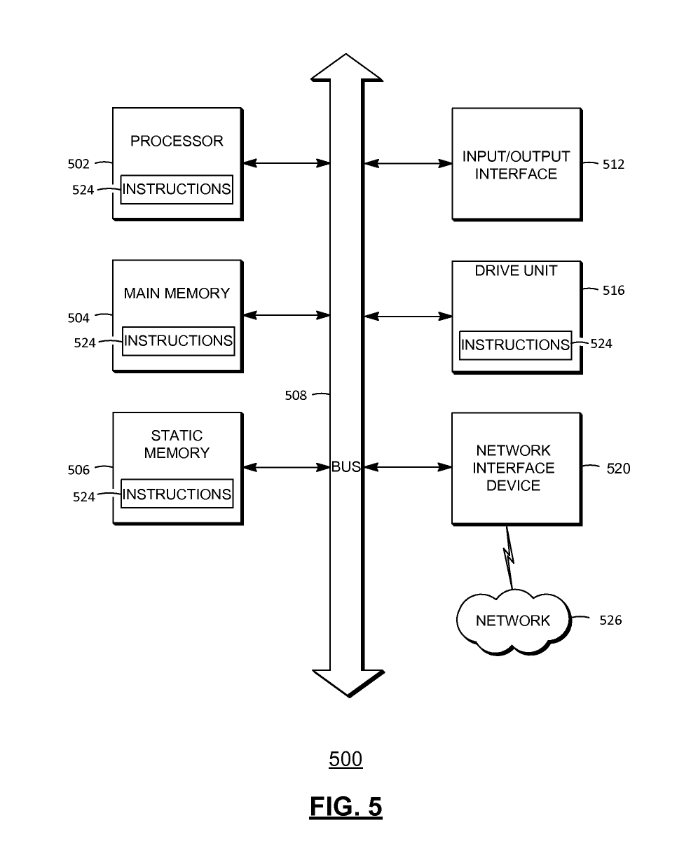

FIG. 5 is a block diagram illustrating a computer system 500 with which any of the clients, servers, or systems described herein may be implemented. In certain aspects, the computer system 500 may be implemented using hardware or a combination of software and hardware, either in a dedicated server, or integrated into another entity, or distributed across multiple entities.

The example computer system 500 includes a processor 502, a main memory 504, a static memory 506, a disk drive unit 516, and a network interface device 520 which communicate with each other via a bus 508. The computer system 500 may further include an input/output interface 512 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 502 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 524 embodying any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media. The instructions 524 may further be transmitted or received over a network 526 via the network interface device 520.

The machine-readable medium may be a single medium or multiple media (e.g., a centralized or distributed database, and/or associated caches and servers) that store the one or more sets of instructions. The machine-readable medium may comprise the drive unit 516, the static memory 506, the main memory 504, the processor 502, an external memory connected to the input/output interface 512, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method for executing a task in a single-threaded environment, the method comprising:
receiving a data set, a first function, and a second function for the task, wherein the data set comprises a plurality of elements;
generating a first set of subtasks based on execution of the first function on each element of the plurality of elements;
scheduling the first set of subtasks for execution in a runtime environment with a single logical thread;
executing, using at least one processor in the runtime environment, the first set of subtasks based on the scheduling of the first set of subtasks, wherein the execution of the first set of subtasks generates a set of key/value pairs;
generating a second set of subtasks based on execution of the second function on the set of key/value pairs;
scheduling the second set of subtasks in the runtime environment; and
executing, using the at least one processor in the runtime environment, the second set of subtasks based on the scheduling of the second set of subtasks.

2. The computer-implemented method of claim 1, wherein each subtask in the second set of subtasks comprises an execution of the second function on all the values associated with one of the keys in the set of key/value pairs.

3. The computer-implemented method of claim 1, wherein the task is a map/reduce task and wherein the first function is a map function and the second function is a reduce function.

4. The computer-implemented method of claim 1, wherein the scheduling of the first set of subtasks and the scheduling of the second set of subtasks enables operations not related to the task to be executed during the execution of the task.

5. The computer-implemented method of claim 1, further comprising receiving at least one scheduling parameter, wherein the scheduling of the first set of subtasks and the scheduling of the second set of subtasks is based on the at least one scheduling parameter.

6. The computer-implemented method of claim 5, wherein the data set, the first function, the second function, and the at least one scheduling parameter are all received via a function call.

7. The computer-implemented method of claim 5, wherein the at least one scheduling parameter is a percentage parameter that specifies a percentage of time in the runtime environment that operations not related to the task are able to be executed.

8. The computer-implemented method of claim 5, wherein the at least one scheduling parameter is a time parameter that specifies an amount of time that subtasks related to the task may be executed in the runtime environment before at least one operation not related to the task is able to be executed.

9. The computer-implemented method of claim 5, wherein the at least one scheduling parameter is a time parameter that specifies an amount of time between subtasks related to the task in which other operations not related to the task is able to be executed.

10. The computer-implemented method of claim 1, wherein the executing of the first set of subtasks comprises executing at least one operation not related to the task between one subtask in the first set of subtasks and a next subtask in the first set of subtasks, and wherein the executing of the second set of subtasks comprises executing at least one other operation not related to the task between one subtask in the second set of subtasks and a next subtask in the second set of subtasks.

11. The computer-implemented method of claim 1, wherein the data set comprises at least one of a list of elements, a spreadsheet, a linked list, or a text file.

12. The computer-implemented method of claim 1, wherein the runtime environment is implemented in a web browser.

13. A non-transitory machine-readable medium comprising instructions stored therein, which when executed by a processor, cause the processor to perform operations comprising:
receiving a data set, a first function, and a second function, wherein the data set comprises a plurality of elements;
generating a first set of subtasks based on execution of the first function on each element of the plurality of elements;
scheduling the first set of subtasks for execution in a single-threaded environment;
executing, in the single-threaded environment, the first set of subtasks based on the scheduling of the first set of subtasks, wherein the execution of the first set of subtasks generates a set of key/value pairs;
generating a second set of subtasks based on execution of the second function on the set of key/value pairs;
scheduling the second set of subtasks in the single-threaded environment; and
executing, in the single-threaded environment, the second set of subtasks based on the scheduling of the second set of subtasks.

14. The non-transitory machine-readable medium of claim 13, wherein each subtask in the second set of subtasks comprises an execution of the second function on all the values associated with one of the keys in the set of key/value pairs.

15. The non-transitory machine-readable medium of claim 13, wherein the task is a map/reduce task and wherein the first function is a map function and the second function is a reduce function.

16. The non-transitory machine-readable medium of claim 13, wherein the scheduling of the first set of subtasks and the scheduling of the second set of subtasks is based on at least one scheduling parameter.

17. The non-transitory machine-readable medium of claim 16, wherein the at least one scheduling parameter is a percentage parameter that specifies a percentage of time in the runtime environment that operations subtasks for the task are able to be executed.

18. A system for executing a task in a single-threaded environment, the system comprising:
at least one processor; and
a machine-readable medium comprising instructions stored therein, which when executed by a processor, cause the processor to perform operations comprising:
receiving a data set, a first function, and a second function, wherein the data set comprises a plurality of elements;
generating a first set of subtasks based on execution of the first function on each element of the plurality of elements;
scheduling the first set of subtasks for execution in a single-threaded environment;
executing, in the single-threaded environment, the first set of subtasks based on the scheduling of the first set of subtasks, wherein the execution of the first set of subtasks generates a set of key;
generating a second set of subtasks based on execution of the second function on the set of key;
scheduling the second set of subtasks in the single-threaded environment; and
executing, in the single-threaded environment, the second set of subtasks based on the scheduling of the second set of subtasks.

19. The system of claim 18, wherein the scheduling of the first set of subtasks and the scheduling of the second set of subtasks enables operations not related to the task to be executed during the execution of the task.

20. The system of claim 18, wherein the executing of the first set of subtasks comprises executing at least one operation not related to the task between one subtask in the first set of subtasks and a next subtask in the first set of subtasks, and wherein the executing of the second set of subtasks comprises executing at least one other operation not related to the task between one subtask in the second set of subtasks and a next subtask in the second set of subtasks.
